(19) United States
(12) Patent Application Publication
(10) Pub. No.: US 2006/0212461 A1
(43) Pub. Date: Sep. 21, 2006

(54) System for organizing a plurality of data sources into a plurality of taxonomies

(76) Inventor: David J. Meysman, Minneapolis, MN (US)

Correspondence Address: NAWROCKI, ROONEY & SIVERTSON;SUITE 401, BROADWAY PLACE EAST, 3433 BROADWAY STREET NORTHEAST, MINNEAPOLIS, MN, 554133009, US

(21) Appl. No.: 11/385,203

(22) Filed: Mar. 21, 2006

Related U.S. Application Data
(60) Provisional application No. 60/663,923, filed on Mar. 21, 2005.

(51) Int. Cl. G06F 7/00; G06F 17/00

(52) U.S. Cl. 707/100

(57) ABSTRACT

A process displays a taxonomy representing an organizational relationship of a plurality of nodes accessible to a computer. A taxonomy file having a user-generated definition of the taxonomy and the nodes is recorded in a data memory. The definitions of the taxonomy and the nodes are extracted from the taxonomy file. The taxonomy definition and the node definitions are provided in a tree node file suitable for interpretation by graphics software. The tree node file is interpreted and used for displaying the contents of the tree node file on a display screen.

This is a regular application filed under 35 U.S.C.§11(a) claiming priority under 35 U.S.C.§119(e)(1), of provisional application Ser. No. 60/663,923 having a filing date of Mar. 21, 2005.

### BACKGROUND OF THE INVENTION

The invention pertains to computer-based processes for organizing data sources to graphically display relationships among them and to simplify access to them. These data sources may be available locally within the computer, provided by an application, or accessible on the Internet.

One familiar protocol for organizing individual records or files and directories is that used by Microsoft Windows, which is one-dimensionally hierarchical. The user can group these data items by into directories or folders. Software in the Windows operating system displays the directory structure and the contents of the directories on a display unit.

The Windows system does not allow for creating multiple associations among the various data items. In the context of accessing data items using the Windows OS, it is satisfactory to associate data items in this way.

The USPTO uses a different protocol in creating a manifold classification system for patents. Contrary to the Windows file management scheme, each patent as well as many other prior art items usually appears in more than one subclass. The PTO system i limited to patents and other types of prior art.

### BRIEF DESCRIPTION OF THE INVENTION

A process displays a taxonomy representing an organizational relationship of a plurality of nodes accessible to a computer. A taxonomy file having a user-generated definition of the taxonomy and the nodes is recorded in a data memory. The definitions of the taxonomy and the nodes are extracted from the taxonomy file. The taxonomy definition and the node definitions are provided in a tree node file suitable for interpretation by graphics software. The tree node file is interpreted and used for displaying the content of the tree node file on a display screen.

### BRIEF DESCRIPTION OF THE DRAWINGS

FIG. 1A shows a simple taxonomy.

FIG. 1B shows a single taxonomy approach to classify the node set.

FIG. 1C shows a node organization having multiple taxonomies with nodes in the node set.

FIG. 1D shows a taxonomy referencing nodes used in other taxonomies, but using different vocabulary.

FIG. 1E shows a node-to-taxonomy association.

FIG. 1F shows a taxonomy of taxonomies.

FIG. 1G is an example of a node-to-node association.

FIG. 1H is an example of a node-to-content association.

FIG. 2 shows examples of pages.xml and taxonomy.xml files in XML format defining a taxonomy.

FIG. 3 shows different pictorial representations of the same taxonomy.

FIG. 4 shows the Javascript array implementing the taxonomy's hierarchical structure.

FIG. 5 shows a user interface generated from XML files shown in FIG. 2.

FIG. 6 shows resulting entries in the file system from XML files in FIG. 2.

FIG. 7 shows the five areas of display in the invention's user interface.

FIG. 8 shows node-to-node associations and their XML representation.

FIG. 9 is a data flow diagram of the process for creating the taxonomy.

FIG. 10 is a data flow diagram for the message processing servlet.

FIG. 11 is a data flow diagram for the pages parser software component.

FIG. 12 is a data flow diagram for the taxonomy parser.

### DESCRIPTION OF THE PREFFERED EMBODIMENTS

General Considerations

Taxonomy and Related Terms

The term “taxonomy” is used in this description as an organizational abstraction, and means a hierarchical organization or group of “things” that have been classified according to some rule. This definition is somewhat different from that employed in the biological sciences, which use the term “taxonomy” to mean the science of classification. The terms classification and taxonomy will be used interchangeably hereafter in this description.

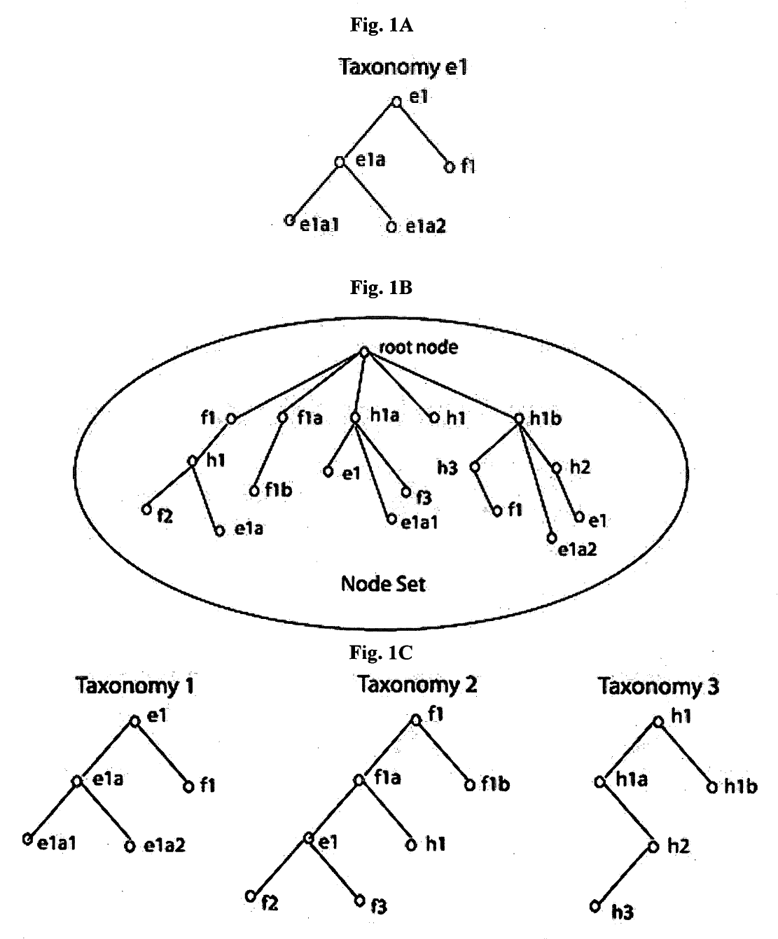

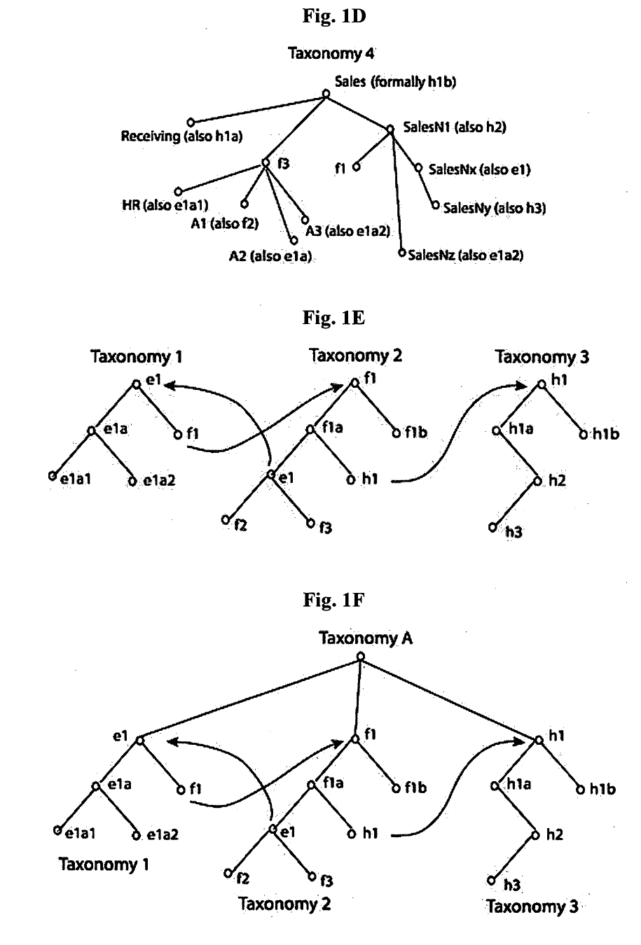

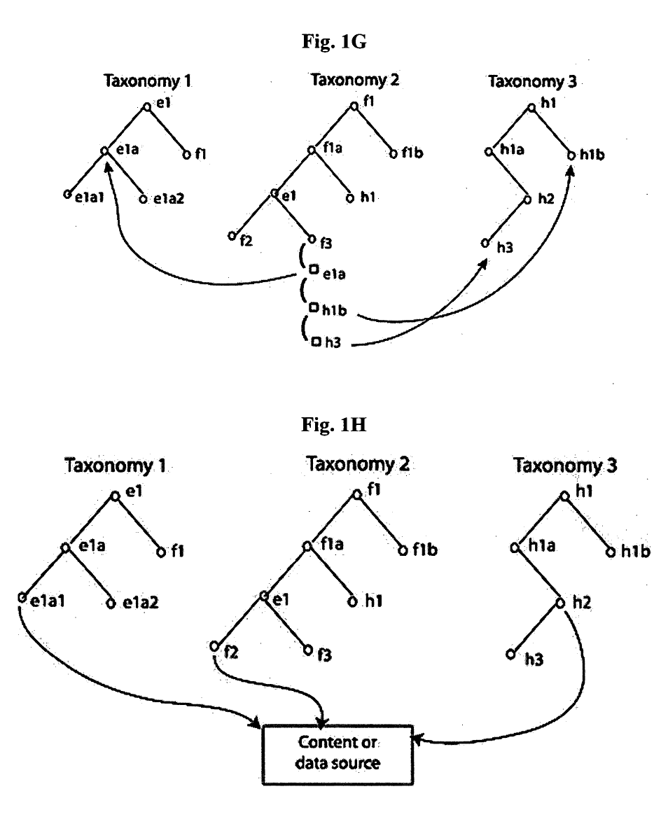

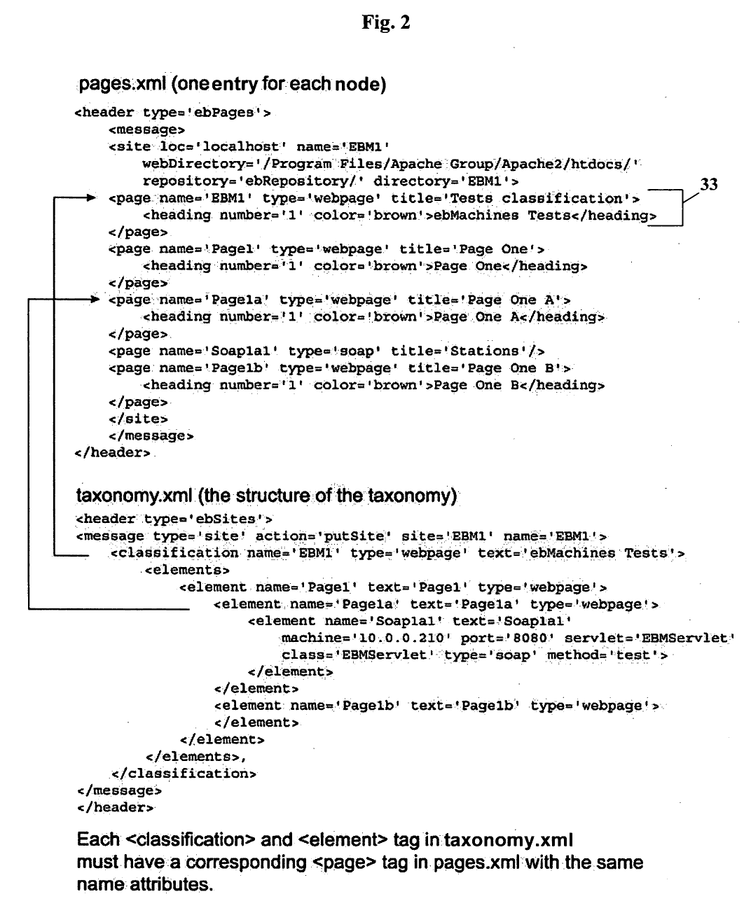

In the field of computer science, a taxonomy is often drawn as a tree. FIG. 1A is an example of such a tree.

Each circle e1, e1a, etc. in the tree is known as a node. A node is one of the things being classified and organized. The lines connecting nodes show how the nodes in a tree are related to one another.

FIG. 1A is a simple example of a taxonomy, where the node e1 is shown as the topmost node, called the root of the tree. The two nodes connected to e1 are e1a and f1. e1a and f1 are known as child nodes of the parent node e1. Any node in the tree will have a parent, except for the root node e1, which has no parent node. A node with no child node is called a leaf such as e1a1 and e1a2.

A taxonomy therefore, is a hierarchical collection of nodes with relationships to one another serving to organize the nodes in a logical and hierarchical manner.

Characteristics of a node can be specified in a file. These characteristics are used when classifying the node.

One preferred way of specifying node characteristics is by using XML or other meta-languages. XML is a text-based language (known as a markup language) that in the case of the invention is used to completely describe each individual taxonomy. XML itself is a standard technology, which is rigorously defined by the W3C (the World Wide Web Consortium; see: http://www.w3.orz/TR/REC-xml/).

### FEATURES OF THE INVENTION

The invention implements ‘multiple taxonomies’ and associations that allows rich content and information classification.

The invention contains the following implemented features:

Multiple taxonomies

Node-to-taxonomy association

Node-to-node association

Node-to-content association

A preferred form of input to the invention is an XML-based description of the taxonomies and nodes supplied by a user. Each of these XML descriptions comprise two files (pages.xml and taxonomy.xml) that specify the name of the taxonomy and the nodes forming the taxonomy, the hierarchical design of the taxonomy, and the hierarchical place in the taxonomy for each node. The description of each node can contain, but is not limited to, the information necessary to access data sources in the invention's data set.

The invention is not limited to only an XML-like description of the taxonomy. In the future it is possible that other types of taxonomy description formats now existing or yet to be developed can be used as input to the invention to describe and generate taxonomies. The important feature of whatever language used is that it is amenable to efficient parsing. For convenience, the specification will present taxonomy and node descriptions in what will be called a “meta-format”, which is to be interpreted as defining an XML file or other file format with relevant characteristics regarding to parsing and processing that are similar to XML.

Use of meta-format files is more a matter of convenience than of necessity. These files are simply a familiar syntax for describing the structure of the taxonomy and the nodes forming a part of the taxonomy.

The Node Set

A taxonomy classifies and organizes a group of things. The invention terms the complete set of “things” that can be classified the node set, because each “thing” in the set is a potential node in a taxonomy. One could consider all the plants of the plant kingdom as a node set, for example. Similarly, the invention could specifically consider the files on the computer to make up the node set; in a content management system, it could consider all the individual pieces of content stored there as the node set. In general terms, however, the node set is defined as a collection of data sources.

The Data Source

A data source any computerized origin of information, including but not limited to the following:

A taxonomy

A computer application

A database

A web service

A web page

A complete content management system

A single document

The invention classifies and organizes data sources in taxonomies by associating individual data sources to nodes of taxonomies. By this definition then, the invention's abstract node set is generally defined as being made up of data sources. The node set's size is only dependent on the ability to access the data sources; it can be as small as a single document, but is theoretically as large as all content and web servers on the Internet.

As new standards come into existence, new types of data sources will also become available. These new data sources may also become part of the node set under consideration as potential nodes in taxonomies.

Classical, Single Taxonomy Approach to Classifying the Node Set

It is necessary to organize the node set so that the things stored there can be found easily and routinely. The classical method of classifying the node set is to incorporate the nodes in the node set into a single taxonomy. Library science, for example, has developed a number of complex methods for organizing printed materials. Using one of these methods such as the hierarchical Dewey Decimal System, printed materials in a library are organized so that patrons can find specific items. Other examples include the biological classification of plants and animals, and the classification of documents held and produced by an organization. FIG. 1B is an example of a single taxonomy. f1, f1a, etc. are nodes organized within the root node shown.

The Problem With the Single Taxonomy Approach

The traditional approach of using a single taxonomy to classify the node set results in a taxonomy that is inherently restrictive, and often fails to “engage” the typical user who may not agree with the approach, the hierarchical design, the granularity of terms or concepts, or the definitions that are assigned to the terms and concepts. Because this approach tries to be all-inclusive, the viewpoints of users are more often than not inadequately met; they may reject the implementation through non-use, which historically has often caused the normal implementation of such systems to fail.

A New, Multiple Taxonomy Approach

The first feature of the invention implements a new approach to classifying the node set which we call a ‘multiple taxonomy approach’. Instead of classifying nodes in a single encompassing taxonomy, the invention makes it possible to develop different classifications of the node set and subsets of the node set to correspond to user needs. Although the invention recognizes the potential need for a taxonomy that classifies the entire node set for administrative purposes (such as the one in FIG. 1B), it also realizes that many more taxonomies can co-exist with the administrative one: for example, the CEO may need to see one or more subsets of the node set, organized in a manner best suited to his needs and logical views of the information; the staff of the sales department, on the other hand, may need access completely different subsets of the node set, organized in totally different ways; and so on.

FIG. 1C shows three related taxonomies 1, 2, and 3. Taxonomy 1 has a parent node e1 and child nodes e1a, f1, etc. Taxonomy 2 has nodes f1a, e1, f1b, etc.

Moreover, the invention does not employ a controlled vocabulary for node names, as a single classification must. While one group of users may call a node by one name, another group may call the same node by a completely different name, even though they in fact are referencing the same node, which will return the same results when activated.

FIG. 1D, for example, shows taxonomy 4 that includes nodes forming a part of taxonomies shown in FIG. 1C. Taxonomy 4 in FIG. 1D uses names different from those shown in FIG. 1C for identical individual nodes in the tree. Thus, nodes “Sales” is the same node as h1b, “Receiving” is the same as node h1a, etc.

Node-to-Taxonomy Association

The invention's second feature implements a node-to-taxonomy concept, as shown in FIG. 1E. Here a node equates to another taxonomy, and presents the concept that a taxonomy itself can be considered a data source. This allows for including other taxonomies within a taxonomy. Consequently, a classification of taxonomies is also possible, as shown in FIG. 1F, resulting in a taxonomy of taxonomies. In FIG. 1F, Taxonomies 1, 2, and 3 are shown as nodes in Taxonomy A.

Node-to-node Association

A node-to-node association is the invention's third implemented feature, as shown in FIG. 1G. In this concept, a node in one taxonomy can reference a node in a different taxonomy, resulting in indirect access to the data sources by the referenced node.

Node-to-content Association

The invention's fourth and final implemented feature is a node-to-content association concept, as shown in FIG. 1H. In this concept, multiple nodes such as e1a1, f2, and h2 can reference the same data source and the content of the data source.

Use of Standardized Technologies

Implementation of the invention is possible because of a number of existing standards and related technologies. Specifically:
The existence of the Internet and the TCP/IP protocol, without which world wide connectivity in standard manner would not be available
The existence of the World Wide Web and its related technologies:
   The browser: for a relatively consistent user interface
   The web server: for delivering web pages
   HTTP: the protocol of the web based on MIME (Multipurpose Internet Mail Extensions)
   Web pages and HTML (the common language of web pages)
   PHP: for server side computing
   Javascript: for client side computing
The standardization of Web Services Description Language which defines the structure of SOAP (Simple Object Access Protocol) messages
XML
File systems
   XML Messages

The invention is built by reading and parsing two XML input files (pages.xml and taxonomy.xml) that together define the taxonomy. FIG. 2 shows the general form of the pages.xml and the taxonomy.xml files. The pages.xml file defines content and the taxonomy.xml file defines structure.

In the context of taxonomy nodes, this application defines content as the result of any action the user would initiate by clicking on a node to access a particular data source. The term ‘content’ is used mainly because the invention's underlying functionality is capable of building web content (i.e., web pages). Content is not limited to this definition, however; for example, clicking on a node could result in the activation of a web service, the results of which would be considered by the software of this invention as “content”.

Taxonomy Hierarchical Structure

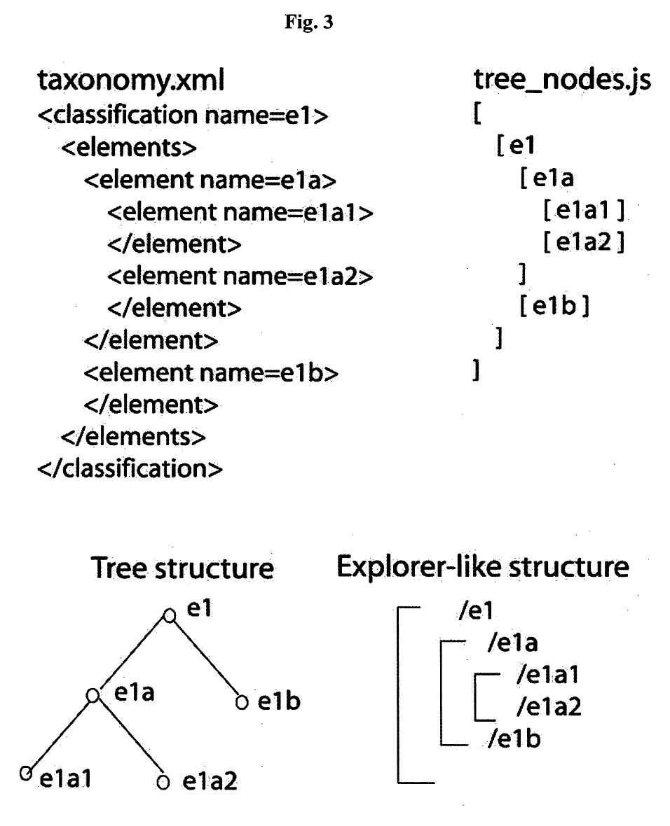

FIG. 3 is an example showing how the taxonomy is represented first in a taxonomy.xml file, and then implemented in a tree_nodes.js file as an array. The Javascript tree_nodes.js file is an array of nodes defining the structure of the taxonomy. This structure corresponds to the structure of elements found in the taxonomy.xml file, which defines the structure of the taxonomy in XML. As the XML file is parsed, nodes are added to the tree_nodes.js file reflecting their relationships to one another, such as ‘parent-child’. As the name implies, tree_nodes.js displays its entries as a tree, albeit in an Explorer-like format.

The file tree_nodes.js is interpreted by a Javascript program to build an Explorer-like implementation of a hierarchical tree structure in the user interface.

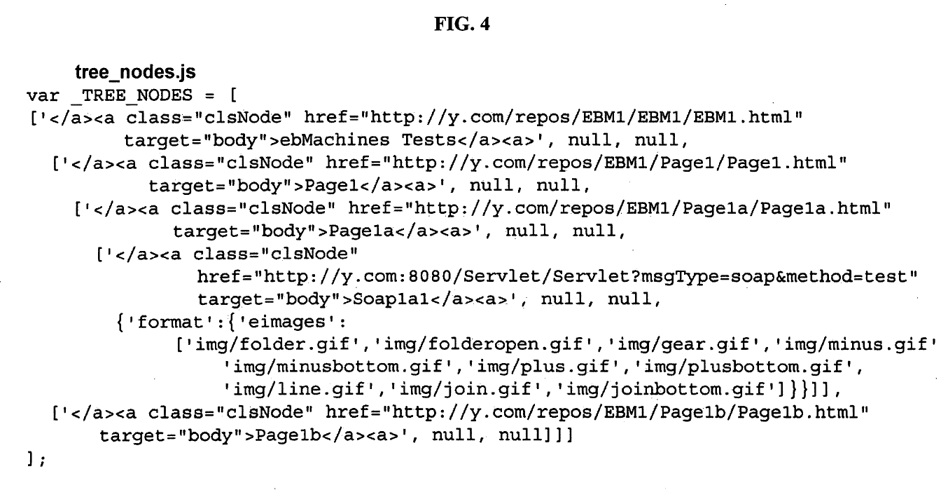

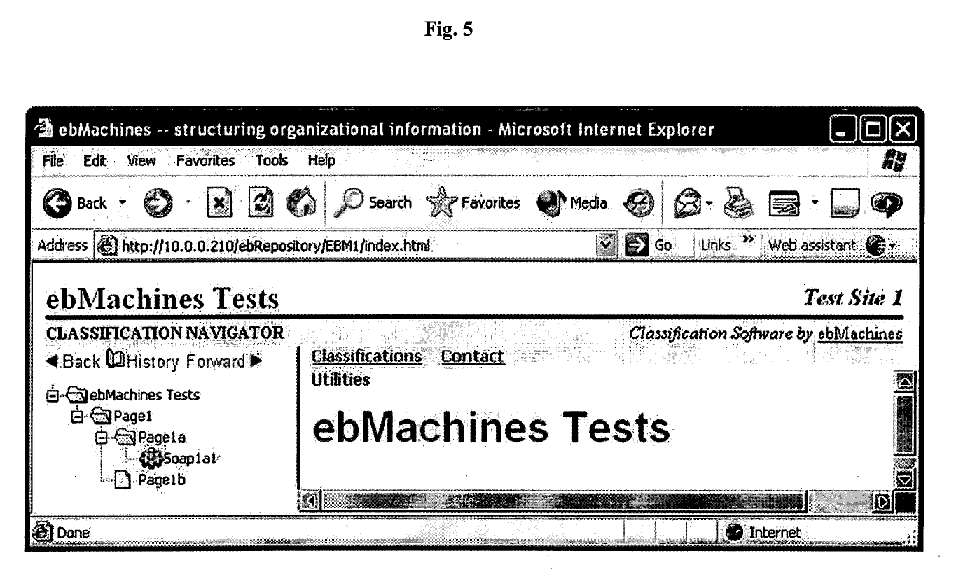

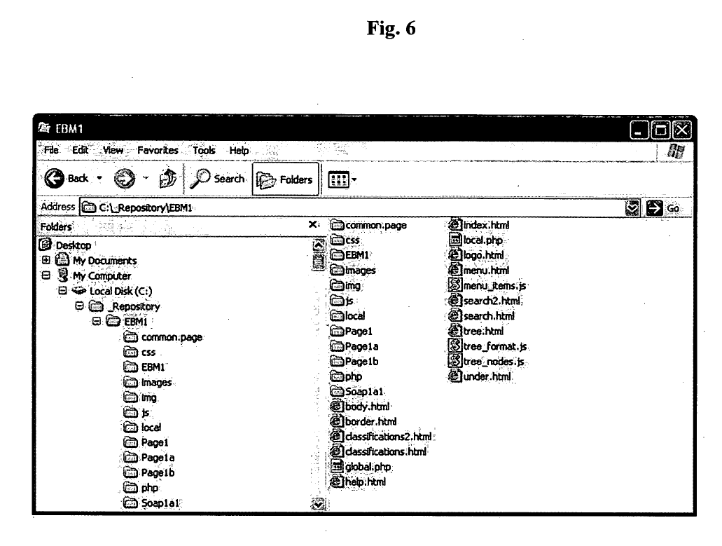

FIG. 2 shows example XML files that are used to build the tree_nodes.js file in FIG. 4 and the taxonomy shown in the UI (user interface) image in FIG. 5. The resulting directory entries in the file system are shown in FIG. 6.

User Interface Design

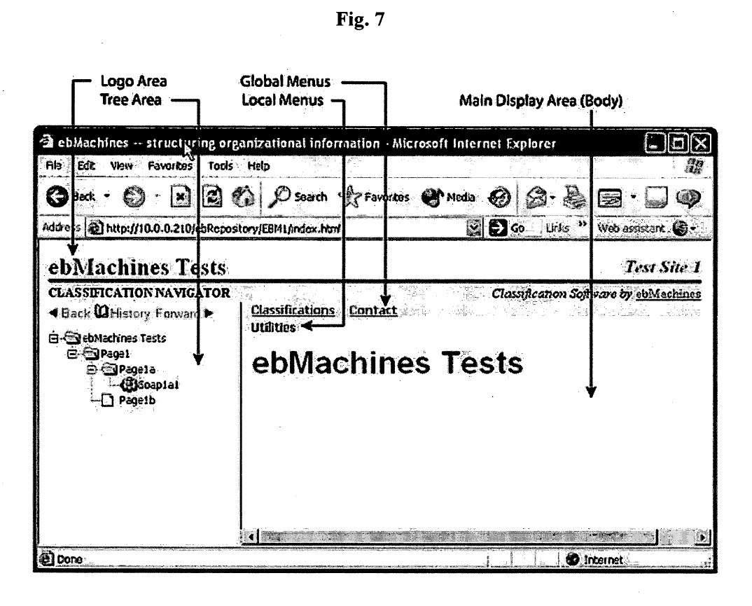

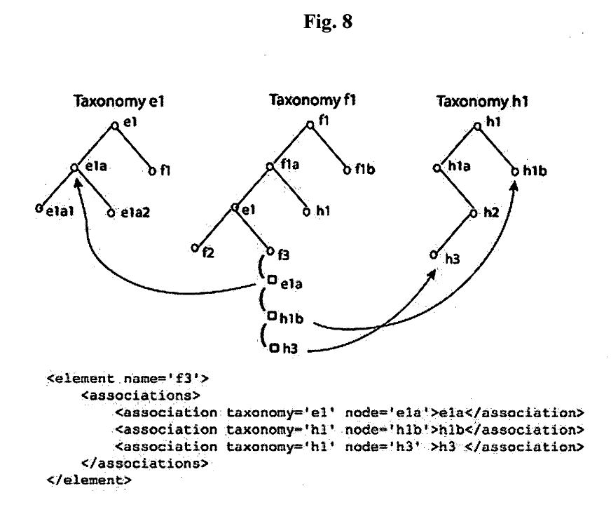

The invention is realized within the framework of a browser based user interface (UI) as shown in FIG. 7. It has five major areas of display, implemented in HTML frames:
1. Tree Area: where the hierarchical display of the taxonomy is displayed
2. Logo Area: where defining graphics for the taxonomy can be displayed
3. Global Menus Area: where a menu system for the entire taxonomy can be displayed and made available to the user
4. Local Menus Area: where a pre-defined menu system for a particular node can be displayed and made available to the user
5. Main Display Area (Body): this is where all returned results from clicks on the taxonomy's tree are displayed.
   Implementation of Node-to-Node Associations

Any classification node may be associated with other classification nodes in other distinct taxonomies. This node-to-node association implies a relationship between the nodes, such as sharing similar content, information or established user interest. These node-to-node associations are similar to taxonomical links, in that they may load different taxonomies when activated; in addition, however, a node reference is always attached to the node-to-node association.

Because of their similarity to taxonomical links, node-to-node associations share all the data structures and software components used to realize multiple taxonomies. While a taxonomical node is not required to have node-to-node associations, it may have one or more such associations, resulting in an association set. A set is implemented in the XML within the <associations> tags, while individual associations are cited using the <association> tag. FIG. 8 is an example of this implementation.

Staging Areas

Data Structures the File System and Required Directories and Files

The invention requires that every taxonomy have its own infrastructure from which to run and display itself to the outside world. This infrastructure is created in a number of directories discussed below. The required files and programs needed by the infrastructure are also described, including the very important file tree_nodes.js, which specifies the taxonomy's hierarchical structure.

Directory Structure

Since the invention is Web- and browser-based, the Web Server plays a critical role in hosting the overall system and software. Specifically, all taxonomies are placed under web server control, located under a special directory called the ‘repository’. Each individual taxonomy is stored as a sub-directory of the repository directory; the constituent nodes of each taxonomy is stored under that taxonomy's sub-directory.

Related files

A number of files are required by an individual taxonomy. These files are copied into the taxonomy's sub-directory:
global.php: defines global variables for the location of the web server's root, the path to the repository, and the name of the repository.
local.php: defines global variables for the taxonomy, such as the actual name of the taxonomy.
index.html: defines the standard frameset for this taxonomy's representation, including a ‘tree’ area for the Explorer-like representation of the taxonomy being viewed, and a ‘body’ area where results from node activations can be displayed.
tree_format.js: formatting instructions to about how each node will be rendered, including instructions on icons to represent different node types.
   Related Directories

Similarly, a number of directories containing files with PHP programs, CSS definitions, and similar operational files are required, and are also copied into the taxonomy's directory:
css/: cascading style sheets for the taxonomical representations, menus and the overall look and feel of web pages.
images/: image files that may be required for this taxonomy, such as a logo.
img/: image files for the rendering of taxonomies
js/: Javascript programs for the menu system and the rendering of the taxonomy.
php/: programs for managing sessions, database interactions, history of taxonomies visited, logging and searching
   Software Components

The invention comprises a set of four software components. Executing these components reads and parses two types of XML input files (pages.xml and taxonomy.xml both shown in FIG. 2) that together define the taxonomy. These reading and parsing actions build a taxonomy.

Parsing is a preferred means of transferring information provided in a predefined format by a user to the system. XML is one suitable format. In general, documents with parsable structures will be referred to as “meta-documents”. The system uses parsing to transform the meta-document contents into the desired taxonomy. Other document formats for transferring this information are possible. For example, a form with blanks to fill is anther possibility.

It is well known that the execution of instructions by a computer causes actual physical changes in the computer itself. For example, current flow through conductors within the computer changes with each instruction execution. Or, as data is stored in the memory, physical changes in the memory occur that represent the stored data. Operation of the invention to be explained below causes changes in the physical state of a display unit so as to allow a human to read the results of computational steps performed by the computer. Accordingly, a process that operates within a computer in point of fact causes a myriad of physical changes to that computer itself. Many of these changes are imperceptible to the naked eye. But nothing in the patent law requires all of the physical changes specified by a process to result in visible changes in matter, or even to have more than fleeting existence. Therefore, the process to be explained below is patentable subject matter.

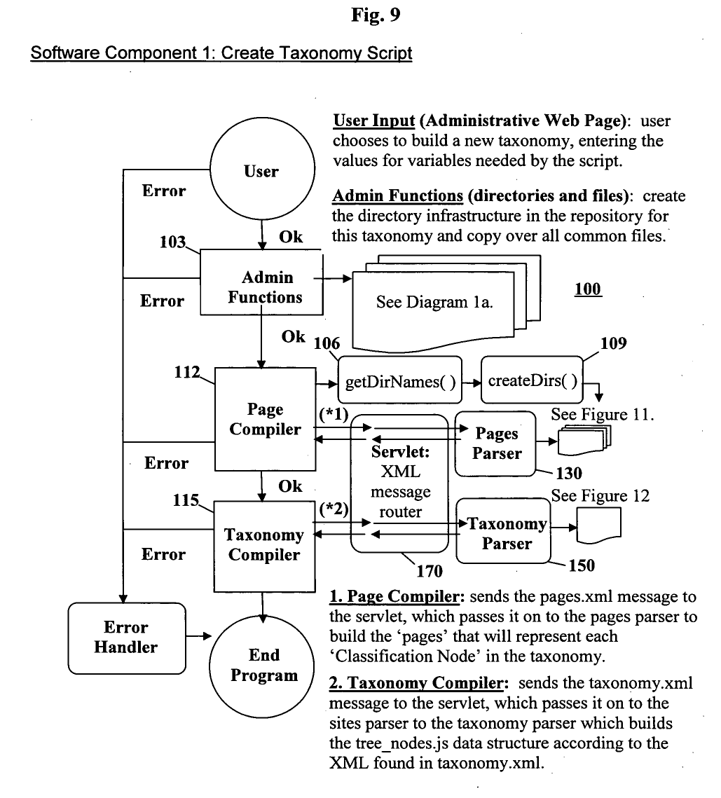

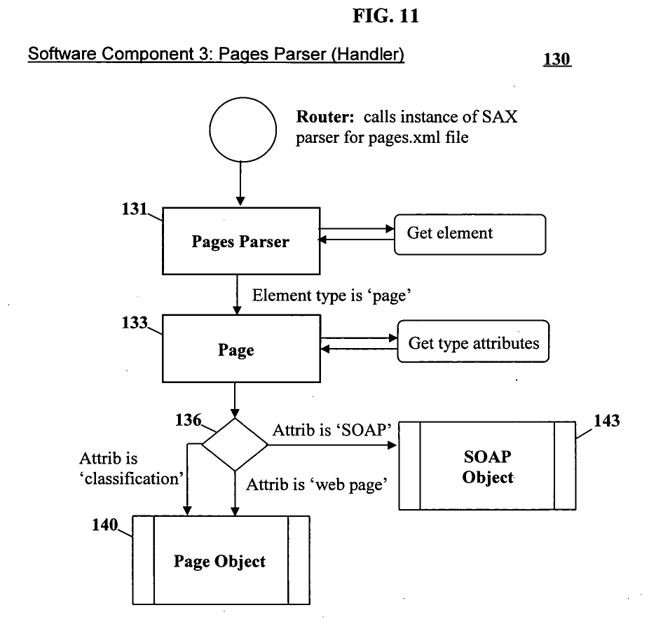

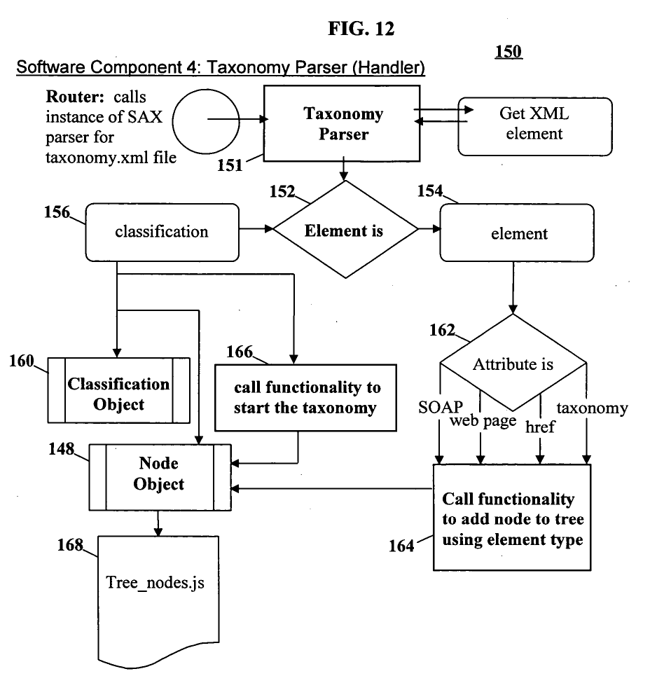

FIGS. 9-12 comprise data flow diagrams that illustrate the actions of these software components. These components are written in a variety of convenient programming languages.

The four software components are:

1. Create Taxonomy Script (100)

2. Message Processing Servlet (170)

3. Pages Parser (130)

4. Taxonomy Parser (150)

1. Create Taxonomy Script (CTS)

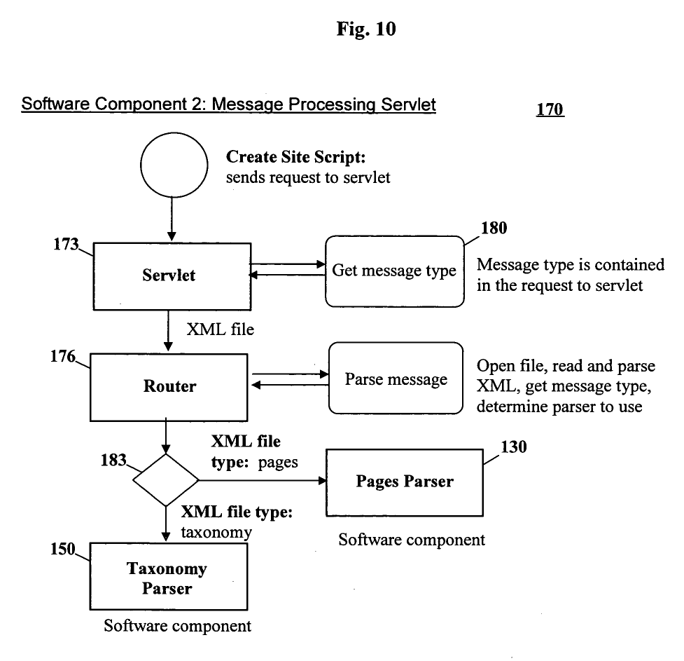

The CTS 100 in FIG. 10 in one implementation is written in Perl language and Shell scripts. The purpose of the CTS 100 is to create a tree_nodes.js file and file system infrastructure which completely describes the hierarchical structure of the taxonomy. The CTS 100 has two main functions:
1. Execute system level commands: creating directories, copying files, doing regular expression substitutions where necessary as described in the Staging Areas section.
2. Send messages to the Message Processing Servlet 170 about actions to take (specifically, to parse the XML messages mentioned in the XML Messages section).

The CTS 100 steps follow and are preferably executed in the indicated order:
Admin Functions 103 includes a step that creates the taxonomy directory if none exists. A representative directory structure called EBM1 is shown in FIG. 6.
When a directory for the new taxonomy already exists, such as EBM1 in FIG. 6, a step in Admin Functions 103 may for archival purposes, rename the existing directory, or may even delete it. In either case, a new directory with the old directory name is then created.
Admin Functions step 103 script copies directories and the files within them from the Staging Area into the taxonomy's directory.
Each node in the taxonomy has a corresponding page element in the pages.xml file, see FIG. 2. In FIG. 2, the paragraph numbered 33 is an example of a single page element. Script in Page Compiler step 112 parses the pages.xml file to create a list of the page names. The getDirNames( ) script (106) steps through the page name list and sequentially call the createDirs script (109) with the name of each page. The createDirs script (109) then creates a new directory for each page and returns to the getDirNames( ) script (106) to process the next page name.
The Page Compiler 112 then sends a pages location signal to the Servlet 170 specifying the location in the memory of the pages.xml file. Servlet 170 sends the pages location signal to the Pages Parser (PP) 130. The PP 130 parses the pages.xml file and loads the parsed information into the taxonomy directory.
The Pages Parser 130 inserts the parsed information in each page element to the node for the node directory for that page element, the script again sends a message to the Servlet 170 with the location of the taxonomy.xml file, which contains the structure of the taxonomy (see the ‘Taxonomy Parser’ section).
At this point all the required directories are built, required files are copied, directories made for each Classification Node, and the pages.xml file for content and the taxonomy.xml file for structure are parsed and acted upon. The taxonomy is built, and the script ends.
If an error occurs at any point in the script, the taxonomy's new directory is renamed for possible inspection later on; if a copy of the directory was made because the taxonomy had been built earlier, the last good build for this taxonomy is renamed from its saved name to the name of the taxonomy.
   2. Message Processor (MP) 170

The Message Processor (MP) 170 includes a Servlet 173 that receives signals encoding parsing request messages from the Page Compiler 112. The Servlet 173 uses software in element 180 to determine the message type. If the message requests parsing of the named file, the file name and location is sent to the Router 176.

Router 176 uses software in element 186 to open the associated file and parses portions of the associated file to extract and store information indicating the proper parser 130 or 150 to use for parsing the file.

Decision element 183 detects the previously stored value specifying the parser and invokes either the Pages Parser component 130 or the Taxonomy Parser component 150.

Two parsing request message types exist:
1. The createPages message type, which is sent to the Pages Parser 130.
2. The createTaxonomy message type, which is sent to the Taxonomy Parser 150.
   3. Pages Parser

The Pages Parser includes a SAX Parser 131 for parsing the pages.xml file described in the ‘XML Messages’ section and shown in FIG. 2. The SAX Parser 131 stores the parsed attributes of the page element. The Page Identifier 133 uses the parsed attributes to store a page type value, which can be one of three values:

1. Classification

2. Web page

3. SOAP

Decision element 136 uses the stored page type value to transfer execution to either the Page Object element 140 or the SOAP Object element 143. If the page type is either ‘classification’ or ‘web page’, a Page Object is created. A SOAP Object is created when the type is SOAP (see Glossary).

Page Object

Using the ‘name’ attribute value found in the page element, for example EBM1 in page element 33, the page object creates an HTML page stored in a file called ‘name’.html. For page element 33 the HTML page file will hold the text “EBM1”. This file is placed in the page element directory associated with the page element, which was made earlier in the process by the ‘Create Taxonomy Script’. Processing all of the page elements in the pages.xml file results in the generation of a web page. A web page generated from the pages.xml file will be of one of several forms:
1. An HTML page: the invention can create HTML pages from the definitions found in pages.xml, but as mentioned this functionality out of scope of this application.
2. A reference to an existing web page: the page will be displayed in ‘body’ frame
3. A place-holder page: a placeholder node is an organizational node in the tree. It is a node that users can click on, but which has no real functionality associated with it. In this case, the tags between the <page> and </page> tags can contain directives the invention will use to build an HTML page for the user to see. This page may only contain the name of the node, or other information designed to tell the user why this node exists (i.e., how it is used for organizational purposes as the parent node of its child nodes). Page elements of type ‘classification’ are treated in exactly the same manner as elements of type ‘web page’: it has its own directory, made for it by the ‘Create Taxonomy Script’, and it is also a functioning web page, since it is the head of the taxonomy. Users will click on the head of the taxonomy (i.e., its top node), and the system will display an HTML page defined between the <page> tags, or a generic page the invention provides for pages without information between the <page> tags.
   SOAP Object

The SOAP Object creates an html page for its <page> tags in a similar manner that the Page Object does. This is done even though at this time the invention expects the SOAP call made to return a displayable page for the ‘body’ of the user interface. Future enhancements may result in more functionality for the HTML page created.

4. Taxonomy Parser 150

The Taxonomy Parser 150 uses a SAX parser 151 to parse the taxonomy.xml file described in the ‘XML Messages’ section and shown in FIG. 2. The taxonomy.xml file contains two kinds of tags that Parser 151 detects:
The “classification” tag
The “element” tag

These tags start character strings containing information the Taxonomy Parser 151 uses to build the tree_nodes.js file shown in FIG. 5. This file, described in the Taxonomy Hierarchical Structure section, contains an array that defines the hierarchy and is used to display the hierarchy.

When the Parser 151 parses a classification tag, it creates two objects:
A ‘classification’ object
A ‘node’ object
   Node Object

The parser calls the functionality to start the taxonomy in the node object upon instantiation. This function writes the initial Javascript needed to create the taxonomy's hierarchical tree to the tree_nodes.js file. As the parser encounters <element> tags in the XML, additional nodes are added to the tree by adding entries to the tree_nodes.js file.

Classification Object

The classification object plays no additional role within the scope of the invention. It is envisioned that this object will play a role in future functionality supporting handheld computers.

The <Element> Tag

When the parser parses an element tag, it then parses the ‘type’ attribute. The ‘type’ attribute determines the kind of node that will be added to the taxonomy's hierarchical tree in tree_nodes.js. There are currently four types of nodes recognized:
A ‘SOAP’ type
A ‘web page’ type
A ‘href’ type
A ‘taxonomy’ type

The following signatures are added to the tree array according to their node type:
‘href’ type.
   Machine address
   Machine port
   HTML reference
   Element name
   Element type
   Element text
‘SOAP’ type:
   Machine address
   Machine port
   Servlet name
   Class name
   Method name
   Element name
   Element type
   Element text
‘web page’ type:
   URL to page
   Element name
   Element type
   Element text
‘taxonomy’ type:
   URL to page
   Element name
   Element type
   Element text

### GLOSSARY

Child node—a node in a taxonomy of nodes that is directly referenced by another node, known as its parent node.
Data source—any computerized origin of information, including but not limited to a taxonomy, an application, a web service, a web page, or a document.
Leaf—a node with no child nodes.
Node—the set of parameters for accessing a data source.
Node set—the global set of all nodes.
Parent node—a node in a taxonomy with child nodes. A parent node itself will have a node superior to it in the hierarchy, which would be called its parent; the exception to this is the root node, which may have children, but does not itself have a parent.
Root node—the node of a taxonomy having no parent.
SOAP—Simple Object Access Protocol; a particular protocol for exchanging information
Taxonomy—a hierarchical organization or classification of nodes indicating logical relationships among the nodes.
Tree—a representation of a hierarchy of things showing how the things in the hierarchy relate to one another.

What I wish to claim by letters patent is:

1. A process for displaying a taxonomy representing an organizational relationship of a plurality of nodes accessible to a computer, comprising:
a) recording in a data memory, a taxonomy file having a user-generated definition of the taxonomy and the nodes;
b) extracting the definitions of the taxonomy and the nodes from the taxonomy file and providing the taxonomy definition and the node definitions in a tree node file suitable for interpretation by graphics software; and
c) interpreting the tree node file and displaying the content of the tree node file on a display screen.

2. The process of claim 1 wherein the step of extracting the definitions of the taxonomy and the nodes comprises parsing the taxonomy file.

3. The process of claim 2, wherein the recording step includes recording a taxonomy file written in meta-format.

4. The process of claim 3, wherein the recording step includes recording a taxonomy file written in XML format.

5. The process of claim 3, wherein the parsing step further includes the step of using the SAX parser.

6. The process of claim 1, wherein the step of recording the taxonomy file includes the step of recording a taxonomy file having at least one node comprising a taxonomy.

7. The process of claim 1, wherein the step of recording the taxonomy file includes the step of recording a plurality of nodes each comprising a taxonomy.
